(19) United States
(12) Patent Application Publication
(10) Pub. No.: US 2023/0299849 A1
(43) Pub. Date: Sep. 21, 2023

(54) METHODS AND DEVICES FOR COMMUNICATIONS

(71) Applicant: NOKIA TECHNOLOGIES OY, Espoo (FI)

(72) Inventor: Lu ZHANG, Beijing (CN)

(21) Appl. No.: 18/020,195

(22) PCT Filed: Aug. 10, 2020
(86) PCT No.: PCT/CN2020/108252

§ 371 Date: Feb. 7, 2023

(51) Int. Cl. H04B 10/116; H04B 3/54

(52) U.S. Cl. CPC H04B 10/116; H04B 3/54; H04W 84/12

(57) ABSTRACT

Methods, apparatuses and devices for communications, wherein a method for communications in a CPE, comprising: receiving a downlink cellular mobile signal from an outdoor base station; transforming the downlink cellular mobile signal to a downlink WLAN signal and sending the downlink WLAN signal to a UE when the downlink cellular mobile signal is handled by WLAN link, and/or transforming the downlink cellular mobile signal to a downlink PLC signal and sending the downlink PLC signal to a VLC-enabled illuminating device when the downlink cellular mobile signal is handled by VLC link; wherein the UE is adapted to do both uplink transmission and downlink reception via WLAN and downlink reception via VLC.

### TECHNICAL FIELD

The teachings in accordance with example embodiments of present disclosure relate generally to wireless communication and, more specifically, relate to communications in Customer Premise Equipment, UEs and VLC-enabled illuminating devices.

### BACKGROUND

This section is intended to provide a background or context for the example embodiments of the present disclosure. The description herein may include concepts that could be pursued, but are not necessarily ones that have been previously conceived or pursued. Therefore, unless otherwise indicated herein, what is described in this section is not prior art of the description and claims in this application and is not admitted to be prior art by inclusion in this section.

Certain Abbreviations that May be Found in the Description and/or in the Figures are Herewith Defined as Follows:
AP Access Point
CPE Customer Premise Equipment
DL Downlink
FWA Fixed Wireless Access
L1/2/3 Layer 1/2/3
MEC Mobile Edge Computing
OFDM Orthogonal Frequency Division Multiplexing
OLC One Logical Cell
O&M Operation and Maintenance
OWC Optical Wireless Communication
PLC Power Line Communications
PoE Power over Ethernet
QoS Quality-of-Service
RAN Radio Access Network
RF Radio Frequency
RSRP Reference Signal Receiving Power
RSRQ Reference Signal Receiving Quality
SINR Signal to Interference plus Noise Ratio
UE User Equipment
UL Uplink
VLC Visible Light Communications

With the increasing demands for the indoor broadband multimedia wireless services, the current RF based solutions have to deal with the serious spectral overcrowding issues. Under this circumstance, VLC, also known as LiFi or OWC, becomes an attractive approach to be a supplement to RF communications for indoor coverage. Efforts have been made to help VLC be more robust in a mobile environment, e.g., Spherical LED, Camera-Based Visual MIMO, etc. Besides, the VLC technology has many other attractive features, such as worldwide availability, a huge and unlicensed bandwidth (i.e., 400T˜800 THz), radiation free (i.e., being more healthy), none of interference to the existing RF networks, being more secure (since light cannot travel through solid objects), etc. Each VLC transmitter could serve as an optical base station or AP and therefore create an extremely small cell, so that several VLC transmitters in an indoor environment could constructe a cellular subsystem, of which there can be several users within each cell. VLC has been proposed to be one of new technologies for future 6G cellular mobile networks. The existing VLC research works focus on the internal designs of VLC subsystem (and especially pay main attention to the designs of L1 and L2); so, it is important to design an efficient way to make the VLC subsystem be connected with external networks, especially be connected with cellular mobile communication networks. In the existing literature, the VLC subsystem accesses the backbone network in wired way via ethernet and hierarchical gateways, so that VLC subsystem is completely independent of cellular mobile systems.

To realize the communication purpose, VLC must access the backbone network, that is to say, the optical APs need to be connected to the core network by high speed backhaul connections. In the prior art, power and data can be provided to each AP via using different techniques, including PoE and PLC. For the way of using PoE, the LED lamp(s) are connected to the network cable and the network cable acts as the backbone; this way requires large modification of the indoor layout and is not cost-effective. The integration of VLC and PLC comes from the observation that all the LED lamps are originally connected to the power line and the power line can naturally act as the backbone for VLC. In this way, the modifications of the indoor cable layout could be avoided as much as possible, so that it is much easier to be installed and is more suitable to the existing buildings (especially the historic buildings). The first PLC and VLC integration prototype was proposed in 2003, using single carrier binary phase shift keying (SC-BPSK) modulation to provide a low rate transmission. Then, OFDM is applied in the hybrid PLC and VLC system to combat the fading channel and achieve higher spectral efficiency.

CPE has been deployed since 4G LTE era. It is a key to FWA, which retains non-negligible market demand in 5G NR era. In the prior art, CPE is only used for the transformation between cellular mobile signals and WiFi signals, using 5G as the example, a CPE receives 5G signals sent from an outdoor base station and transforms these 5G signals to be WiFi signals in the DL; also, it receives WiFi signals sent from multiple users and transforms these WiFi signals to be 5G signals in the UL, in this manner, multiple users can access the 5G network via this CPE. On one hand, a CPE acts as a wireless home gateway; on the other hand, a CPE could be viewed as an “super” UE, to which multiple users who transmit/receive WiFi signals are transparent. Besides, CPE could also play an important role in acting as central pivot of smart home and undertaking MEC equipment.

### SUMMARY

The scope of protection sought for various embodiments of the present disclosure is set out by the independent claims. The embodiments and features, if any, described in this specification that do not fall under the scope of the independent claims are to be interpreted as examples useful for understanding various embodiments of the present disclosure.

According to a first aspect, various embodiments provide a method for communications in a CPE, comprising:
receiving a downlink cellular mobile signal from an outdoor base station;
transforming the downlink cellular mobile signal to a downlink WLAN signal and sending the downlink WLAN signal to a UE when the downlink cellular mobile signal is handled by WLAN link, and/or, transforming the downlink cellular mobile signal to a downlink PLC signal and sending the downlink PLC signal to a VLC-enabled illuminating device when the downlink cellular mobile signal is handled by VLC link;
wherein the UE is adapted to do both uplink transmission and downlink reception via WLAN and downlink reception via VLC.

According to some embodiments, the method further comprises:
receiving an uplink WLAN signal sent from the UE and/or an uplink PLC signal sent from the VLC-enabled illuminating device, and transforming the uplink WLAN signal and/or the uplink PLC signal to an uplink cellular mobile signal, wherein the uplink PLC signal is generated at the VLC-enabled illuminating device by transforming the uplink VLC signal sent from the UE that also adapted to do uplink transmission via VLC;
sending the uplink cellular mobile signal to the outdoor base station.

According to some embodiments, wherein the UE is connected to the CPE via both WLAN link and VLC link after moving into the overlapped coverage of WLAN network and VLC network, for a service whose traffic is first carried by WLAN link and later taken over by VLC link, the starting time point of transmission for the packet with the packet index k+i (i>=1) is taken as the time point of data transmission through the VLC link, k is the packet index of the packet currently transmitted by WLAN link when the establishment of VLC link with UE is completed, the value of i depends on the downlink channel quality measurement over the VLC link.

According to some embodiments, wherein the last packet transmitted through the VLC link is retransmitted through WLAN link when the VLC link is lost.

According to some embodiments, wherein the CPE acts as both a WLAN AP and an OLC-type VLC AP, wherein, the role of OLC-type VLC AP is formed by making all the VLC-enabled illuminating devices that share the PLC modem in the CPE have one unique cell ID.

According to a second aspect, various embodiments provide a method for communications in a VLC-enabled illuminating device, comprising:
receiving a downlink PLC signal from a CPE;
transforming the downlink PLC signal to a downlink VLC signal, and sending the downlink VLC signal to a UE, wherein the UE is adapted to do both uplink transmission and downlink reception via WLAN and downlink reception via VLC.

According to some embodiments, the method further comprises:
receiving an uplink VLC signal sent from the UE, wherein the UE is also adapted to do uplink transmission via VLC;
transforming the uplink VLC signal to an uplink PLC signal, and sending the uplink PLC signal to the CPE.

According to a third aspect, various embodiments provide a method for communications in a UE, wherein the UE is adapted to do both uplink transmission and downlink reception via WLAN and downlink reception via VLC, comprising:
receiving a downlink VLC signal from a VLC-enabled illuminating device and/or a downlink WLAN signal from a CPE, wherein the downlink VLC signal is transformed from a downlink PLC signal sent from the CPE.

According to some embodiments, wherein the UE is connected to the CPE via both WLAN link and VLC link after moving into the overlapped coverage of WLAN network and VLC network, the step of receiving comprises:
receiving a downlink VLC signal from the VLC-enabled illuminating device and/or a downlink WLAN signal from the CPE according to the working mode of the UE, wherein the working mode of the UE is determined according to its service type and/or its wireless channel condition;
wherein the method further comprises:
sending an uplink WLAN signal to the CPE if the UE is not adapted to do uplink transmission via VLC, or sending an uplink WLAN signal to the CPE and/or an uplink VLC signal to the VLC-enabled illuminating device according to the working mode of the UE if the UE is also adapted to do uplink transmission via VLC.

According to some embodiments, wherein, at either downlink or uplink direction, the working mode is any of the following modes: WLAN single-link mode, VLC single-link mode, traffic splitting mode;
wherein, all the currently activated services of the UE are handled by WLAN link in the WLAN single-link mode, all the currently activated services of the UE are handled by VLC link in the VLC single-link mode, some services of the UE which have high demand on throughput are handled by VLC link and other services of the UE are handled by WLAN link in the traffic splitting mode.

According to some embodiments, wherein the VLC link between the UE and an outdoor VLC-enabled illuminating device is established if the UE is outdoors, some services of the UE which have high demand on throughput are handled by VLC link; wherein the downlink VLC signal is transformed from a downlink PLC signal sent from the CPE and the uplink VLC signal is transformed to an uplink PLC signal sent to the CPE if the UE is also adapted to do uplink transmission via VLC.

According to a fourth aspect, various embodiments provide a CPE for communications, comprising:
means for receiving a downlink cellular mobile signal from an outdoor base station;
means for transforming the downlink cellular mobile signal to a downlink WLAN signal and sending the downlink WLAN signal to a UE when the downlink cellular mobile signal is handled by WLAN link, and/or transforming the downlink cellular mobile signal to a downlink PLC signal and sending the downlink PLC signal to a VLC-enabled illuminating device when the downlink cellular mobile signal is handled by VLC link;
wherein the UE is adapted to do both uplink transmission and downlink reception via WLAN and downlink reception via VLC.

According to a fifth aspect, various embodiments provide a VLC-enabled illuminating device for communications, comprising:
means for receiving a downlink PLC signal from a CPE;
means for transforming the downlink PLC signal to a downlink VLC signal, and sending the downlink VLC signal to a UE, wherein the UE is adapted to do both uplink transmission and downlink reception via WLAN and downlink reception via VLC.

According to a sixth aspect, various embodiments provide a UE for communications, wherein the UE is adapted to do both uplink transmission and downlink reception via WLAN and downlink reception via VLC, comprising:
means for receiving a downlink VLC signal from a VLC-enabled illuminating device and/or a downlink WLAN signal from a CPE, wherein the downlink VLC signal is transformed from a downlink PLC signal sent from the CPE.

According to a seventh aspect, various embodiments provide a CPE for communications, comprising:
at least one memory;
a battery module;
a UE modem chipset for L1 and L2 processing of a cellular mobile signal, L3 control-plane processing of the cellular mobile signal, none or part of L3 user-plane processing of the cellular mobile signal, wherein, the UE modem chipset is used for transformation between a cellular mobile signal and IP data packets;
a networking processor for all or part of L3 user plane processing of the cellular mobile signal, L3 processing of a WLAN signal, L3 processing of a PLC signal, O&M configuration of the accessed UEs, wherein, the networking processor is used for sending IP data packets sent from the UE modem chipset into the WLAN modem chipset and/or the PLC modem chipset, or sending IP data packets sent from the WLAN modem chipset and/or the PLC modem chipset into the UE modem chipset;
a WLAN modem chipset for L1 and L2 processing of a WLAN signal, wherein, the WLAN modem chipset is used for transformation between IP data packets and WLAN signal;
a PLC modem chipset for L1 and L2 processing of a PLC signal, wherein, the PLC modem chipset is used for transformation between IP data packets and PLC signal.

According to an eighth aspect, various embodiments provide a CPE for communications, comprising:
at least one processor; and
at least one memory including computer program code;
the at least one memory and the computer program code configured to, with the at least one processor, cause the CPE at least to perform:
receiving a downlink cellular mobile signal from an outdoor base station;
transforming the downlink cellular mobile signal to a downlink WLAN signal and sending the downlink WLAN signal to a UE when the downlink cellular mobile signal is handled by WLAN link, and/or transforming the downlink cellular mobile signal to a downlink PLC signal and sending the downlink PLC signal to a VLC-enabled illuminating device when the downlink cellular mobile signal is handled by VLC link;
wherein the UE is adapted to do both uplink transmission and downlink reception via WLAN and downlink reception via VLC.

According to a ninth aspect, various embodiments provide a VLC-enabled illuminating device for communications, comprising:
at least one processor; and
at least one memory including computer program code;
the at least one memory and the computer program code configured to, with the at least one processor, cause the VLC-enabled illuminating device at least to perform:
receiving a downlink PLC signal from a CPE;
transforming the downlink PLC signal to a downlink VLC signal, and sending the downlink VLC signal to a UE, wherein the UE is adapted to do both uplink transmission and downlink reception via WLAN and downlink reception via VLC.

According to a tenth aspect, various embodiments provide a UE for communications, wherein the UE is adapted to do both uplink transmission and downlink reception via WLAN and downlink reception via VLC, comprising:
at least one processor; and
at least one memory including computer program code;
the at least one memory and the computer program code configured to, with the at least one processor, cause the UE illuminating device at least to perform:
receiving a downlink VLC signal from a VLC-enabled illuminating device and/or a downlink WLAN signal from a CPE, wherein the downlink VLC signal is transformed from a downlink PLC signal sent from the CPE.

According to an eleventh aspect, various embodiments provide a non-transitory computer readable medium comprising program instructions for causing a device to perform at least the following:
receiving a downlink cellular mobile signal from an outdoor base station;
transforming the downlink cellular mobile signal to a downlink WLAN signal and sending the downlink WLAN signal to a UE when the downlink cellular mobile signal is handled by WLAN link, and/or transforming the downlink cellular mobile signal to a downlink PLC signal and sending the downlink PLC signal to a VLC-enabled illuminating device when the downlink cellular mobile signal is handled by VLC link;
wherein the UE is adapted to do both uplink transmission and downlink reception via WLAN and downlink reception via VLC.

According to a twelfth aspect, various embodiments provide a non-transitory computer readable medium comprising program instructions for causing a device to perform at least the following:
receiving a downlink PLC signal from a CPE;
transforming the downlink PLC signal to a downlink VLC signal, and sending the downlink VLC signal to a UE, wherein the UE is adapted to do both uplink transmission and downlink reception via WLAN and downlink reception via VLC.

According to a thirteenth aspect, various embodiments provide a non-transitory computer readable medium comprising program instructions for causing a device which is adapted to do both uplink transmission and downlink reception via WLAN and downlink reception via VLC to perform at least the following:
receiving a downlink VLC signal from a VLC-enabled illuminating device and/or a downlink WLAN signal from a CPE, wherein the downlink VLC signal is transformed from a downlink PLC signal sent from the CPE.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of embodiments of the disclosure and are not necessarily drawn to scale, in which:

FIG. 1 shows an exemplary flow chart for communications in a CPE according to an embodiment of the present disclosure;

FIG. 2 shows an exemplary DL data transmission mechanism;

FIG. 3 shows another exemplary DL data transmission mechanism;

FIG. 4 shows an exemplary flow chart for communications in a VLC-enabled illuminating device according to an embodiment of the present disclosure;

FIG. 5 shows an exemplary flow chart for communications in a UE according to an embodiment of the present disclosure;

FIG. 6 shows an exemplary structural diagram of a first apparatus for communications in a CPE according to an embodiment of the present disclosure;

FIG. 7 shows an exemplary structural diagram of a second apparatus for communications in a VLC-enabled illuminating device according to an embodiment of the present disclosure;

FIG. 8 shows an exemplary structural diagram of a third apparatus for communications in a UE according to an embodiment of the present disclosure;

FIG. 9 shows an exemplary structural diagram of UE according to an embodiment of the present disclosure;

FIG. 10 shows an exemplary structural diagram of UE according to an embodiment of the present disclosure;

FIG. 11 shows an exemplary system for communications according to an embodiment of the present disclosure.

### DETAILED EMBODIMENTS

Principle of the present disclosure will now be described with reference to some example embodiments. It is to be understood that these example embodiments are described only for the purpose of illustration and for helping those skilled in the art to understand and implement the present disclosure, without suggesting any limitation as to the scope of the disclosure. The embodiments described herein can be implemented in various manners which are not limited to the ones described below.

In the following description and claims, unless defined otherwise, all technical and scientific terms used herein have the same meaning as commonly understood by one of ordinary skills in the art to which this disclosure belongs.

As used herein, the term “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to a network node on predetermined schedules, when triggered by an internal or external event, or in response to requests from the network side. The UE described in this disclosure has at least the ability for uplink transmission and downlink reception via WLAN and the ability for downlink reception via VLC. In some embodiments, the UE is adapted to do both uplink transmission and downlink reception via WLAN, and only do downlink reception via VLC. In some embodiments, the UE is adapted to do both uplink transmission and downlink reception via WLAN, and do uplink transmission and downlink reception via VLC.

As used herein, the term “VLC-enabled illuminating device” refers to an illuminating device that supports VLC, the VLC-enabled illuminating device has a module to do transformation between PLC signals and VLC signals. The VLC-enabled illuminating device may only have the ability for DL transmission via VLC, or it may have the ability for both DL transmission and UL reception via VLC. Examples of the VLC-enabled illuminating device includes a fluorescent lamp, a LED lamp, consists of LED lamps in an array, and the like.

The communication system and associated devices (e.g., UE and network nodes) typically operate in accordance with a given standard or specification which sets out what various entities associated with the system are permitted to do and how that should be achieved. Communication protocols and/or parameters which shall be used for the connection are also typically defined. The examples of a communication system include Long-Term Evolution (LTE) of the Universal Mobile Telecommunications System (UMTS) and New Radio (NR) system (i.e., the so-called 5G system). As used herein, the term of “base station” refers to a device via which services can be provided to a terminal device in a communication network, examples of the base station include a node B (NodeB or NB), an evolved NodeB (eNodeB or eNB), a NR NodeB (gNB), and the like.

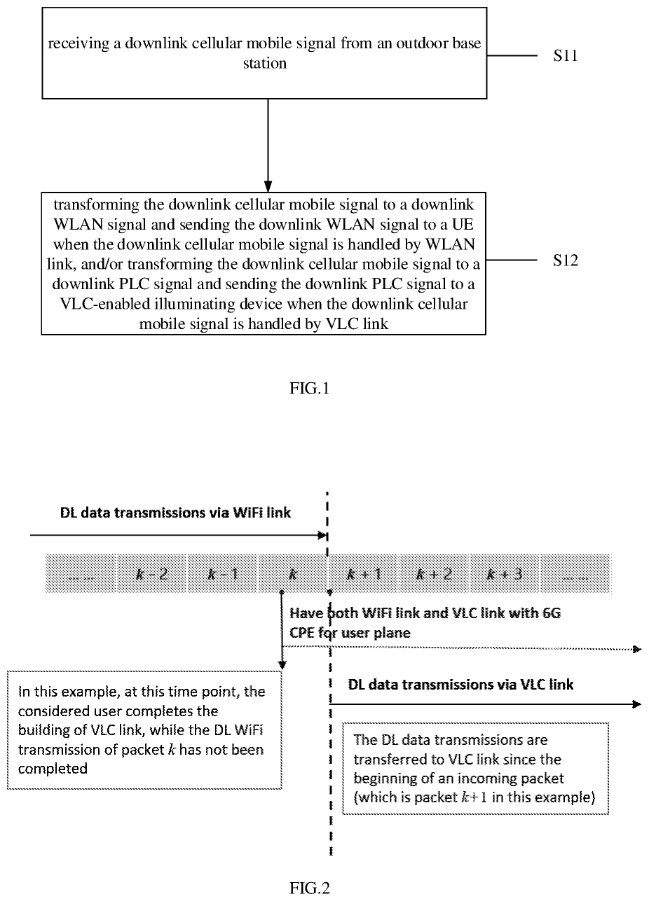

FIG. 1 shows an exemplary flow chart for communications in a CPE according to an embodiment of the present disclosure. The method according to the embodiment includes steps S11 and S12.

The term CPE described in this disclosure can support not only the transformation between cellular mobile signals and WLAN signals, but also the transformation between cellular mobile signals and PLC signals. The cellular mobile signals include signals in existing or future cellular mobile systems, such as 2G/3G/4G/5G/6G signals. Using 6G as an example, the CPE consists of a 6G UE modem chipset, a networking processor, a WLAN modem chipset, and a PLC modem chipset, in DL, the CPE has the ability to transform 6G signals sent from an outdoor 6G base station to either PLC signals or WLAN signals, in UL, the CPE has the ability to transform PLC signals or WLAN signals to 6G signals. What needs to be explained is, about whether VLC will be viewed as one WLAN technique in the future, it is an unknown issue now, but, in this disclosure, the term WLAN explicitly and definitely excludes VLC. In some preferred embodiments, the term WLAN described in this disclosure means WiFi.

In step S11, the CPE receives a downlink cellular mobile signal from an outdoor base station. The outdoor base station is the serving base station of the CPE. For example, the CPE receives a downlink 6G signal sent from an outdoor 6G base station.

In step S12, the CPE transforms the downlink cellular mobile signal to a downlink WLAN signal and sending the downlink WLAN signal to a UE when the downlink cellular mobile signal is handled by WLAN link, and/or transforms the downlink cellular mobile signal to a downlink PLC signal and sending the downlink PLC signal to a VLC-enabled illuminating device when the downlink cellular mobile signal is handled by VLC link. The UE described in this disclosure is adapted to do both uplink transmission and downlink reception via WLAN and downlink reception via VLC, for example, the UE includes a WiFi transceiver and a VLC receiver. In this disclosure, the realistic PLC-assisted VLC subsystem is considered, specifically the CPE connected to multiple VLC-enabled illuminating device through power lines, each VLC-enabled illuminating device (i.e., each VLC AP) has a signal transformation module which is used for transforming between PLC signals and VLC signals. As an example, in DL, upon receiving a 6G signal sent from an outdoor 6G base station which is the serving 6G base station of the CPE, the CPE first transforms the 6G signal to L3 user plane data, then transforms the L3 user-plane data to a downlink WLAN signal (e.g., a downlink WiFi signal) if the 6G signal is handled by WLAN link (e.g., WiFi link) and sends the downlink WLAN signal to a UE. As another example, in DL, upon receiving a 6G signal sent from an outdoor 6G base station which is the serving 6G base station of the CPE, the CPE first transforms the 6G signal to L3 user plane data, then transforms the L3 user plane data to a downlink PLC signal if the 6G signal is handled by VLC link, and then sends the downlink PLC signal to a VLC-enabled illuminating device, the VLC-enabled illuminating device will transform the PLC signal to a VLC signal and send the VLC signal to a UE. In some embodiments, in DL, upon receiving a 6G signal sent from an outdoor 6G base station which is the serving 6G base station of the CPE, the CPE transforms part of the 6G signal to a downlink WiFi signal and transforms the other part of the 6G signal to a downlink PLC signal, then the CPE sends the downlink WiFi signal to a UE and sends the downlink PLC signal to a VLC-enabled illuminating device through power line.

In some embodiments, the method in CPE further comprises: receiving an uplink WLAN signal sent from the UE and/or an uplink PLC signal sent from the VLC-enabled illuminating device, and transforming the uplink WLAN signal and/or the uplink PLC signal to an uplink cellular mobile signal, wherein the uplink PLC signal is generated at the VLC-enabled illuminating device by transforming the uplink VLC signal sent from the UE that also adapted to do uplink transmission via VLC; sending the uplink cellular mobile signal to the outdoor base station.

In some embodiments, the CPE receives an uplink WLAN signal sent from the UE, and transforms an uplink WLAN signal to an uplink cellular mobile signal, then the CPE sends the uplink cellular mobile signal to the outdoor base station. If the indoor UE does not have the ability to do UL transmission via VLC (i.e., the UE is not adapted to do UL transmission via VLC), the CPE can only receive uplink WLAN signals sent from the UE.

In some embodiments, the CPE receives an uplink PLC signal sent from the VLC-enabled illuminating device, and transforms the uplink PLC signal to an uplink cellular mobile signal, then the CPE sends the uplink cellular mobile signal to the outdoor base station, wherein the uplink PLC signal is generated at the VLC-enabled illuminating device by transforming the uplink VLC signal sent from the UE, wherein the UE is also adapted to do uplink transmission via VLC. In these embodiments, the indoor UE can do UL transmission via not only WLAN but also VLC, and the VLC-enabled illuminating devices are adapted to do not only DL transmission but also UL reception via VLC.

In some embodiments, the CPE receives an uplink WLAN signal sent from the UE and an uplink PLC signal sent from the VLC-enabled illuminating device, then transforms the uplink PLC signal and the uplink PLC signal to an uplink cellular mobile signal, and sends the uplink cellular mobile signal to the outdoor base station.

In other words, in UL, two optional subcases as following are considered:
i) if indoor users (i.e., UEs) do not have the ability to do UL transmission via VLC, this CPE receives WLAN signals sent from indoor users and transforms these WLAN signals to be cellular mobile signals;
ii) if indoor users can do UL transmission via not only WLAN but also VLC and if the VLC-enabled illuminating devices have the ability for not only DL transmission but also UL reception via VLC, the CPE receives WLAN signals (sent from some indoor users) and PLC signals (transformed by VLC signals sent from another indoor users), and then transforms these WLAN signals and PLC signals to be cellular mobile signals.

In the prior art, the VLC subsystem accesses the backbone network in wired way via ethernet and hierarchical gateways, so that VLC subsystem is completely independent of cellular mobile systems. With the usage of the CPE described in this disclosure, the VLC subsystem can really be integrated into cellular mobile communication systems (such as 6G or other future cellular mobile communication systems), because the VLC subsystem accesses the backbone network in wireless way via radio access network (RAN) of cellular mobile systems. In another words, the signals of indoor users (which are able to do VLC for at least DL) would go through RAN and core network of cellular mobile communication systems before accessing application (e.g., Internet application), resulting in shorter end-to-end transmission latency than prior VLC solutions and making the VLC subsystem become a part of 6G cellular mobile systems.

Considering that the co-existence of WLAN and VLC for indoor coverage is a reasonable deployment tendency in the future, this disclosure uses the co-deployment of WLAN and VLC as the basic network deployment for indoor coverage. In some embodiments, with the management of the CPE described in this disclosure, the indoor coverage could be viewed as being implemented by the co-existence of VLC AP(s) and WLAN AP(s). That is to say, the CPE acts as both a WLAN AP and an OLC type VLC AP.

In terms of WLAN access, one CPE generally acts as one WLAN AP for the communications between CPE and indoor user(s).

In terms of VLC access, one CPE acts as one OLC-type VLC AP for the communications between CPE and indoor user(s). That is, all the VLC-enabled illuminating devices, which share one common PLC modem in the CPE, formulate one OLC-type VLC AP (i.e., all of these VLC-enabled illuminating devices have one unified cell ID); in this way, the frequent handover between VLC-enabled illuminating devices could be avoided. In contrast, for the existing way, each VLC-enabled illuminating devices is a VLC AP and has a unique cell ID, so that a handover procedure (including several control signals) will be initiated, once the considered indoor user walks from the coverage of one VLC-enabled illuminating device into the coverage of another neighboring VLC-enabled illuminating device; thus, in general, frequent handover (which means a significant amount of control overhead) between VLC-enabled illuminating devices will be caused, because the distance between any two indoor VLC-enabled illuminating devices are generally close.

In some embodiments, one or more pure WLAN routers are bridged with the CPE to act as secondary WLAN APs based on using WLAN bridging technology, and/or, one or more pure PLC routers are bridged with the CPE based on using PLC bridging technology where all the VLC-enabled illuminating devices that share one bridged PLC router formulate a secondary OLC-type VLC AP. For example, if needed (e.g., in a house with two floors), another one or more pure WiFi router(s) can, based on using WiFi bridging technology, be bridged with the CPE to act as secondary WiFi AP(s). For another example, if needed, another one or more pure PLC router(s) can, based on using PLC bridging technology, be bridged with the CPE, and all the VLC-enabled illuminating devices that share one bridged PLC router formulate a secondary OLC-type VLC AP.

Under the co-existence of VLC and WLAN for indoor coverage, VLC coverage is generally a subset of WLAN coverage. For any WLAN user which moves into the overlapped coverage of VLC and WLAN, it is proposed in this disclosure to let this user keep both WLAN link and VLC link with the CPE. Then, with the dual connectivity, no handover between WLAN AP and VLC AP is needed.

Using the DL user-plane transmission as the example, for any WLAN user that moves into the overlapped coverage of VLC and WLAN, once the user builds VLC link, for some service(s) of the user which have high demand on throughput (e.g., file downloading, on-line movie watching, etc.), the corresponding data transmission will be taken over by VLC link.

The peak throughput of VLC could reach several Gbps (based on the existing experiments), which is much larger than the peak throughput of WLAN. Thus, as the examples, once the DL data transmission of the corresponding service(s) are taken over by VLC link, the file downloading will be completed soon and the on-line movie watching will become much smoother. For making DL data transmission is smoothly linked up between WLAN link and VLC link, this disclosure proposes the following transmission mechanism.

In some embodiments, the UE is connected to the CPE via WLAN link and VLC link after moving into the overlapped coverage of WLAN network and VLC network (i.e., the UE keeps both WLAN link and VLC link with the CPE), for a service whose traffic is first carried by WLAN link and later taken over by VLC link, the starting time point of transmission for the packet with the packet index k+i (i>=1) is taken as the starting time point of data transmission through the VLC link, k is the packet index of the packet currently transmitted by WLAN link when the establishment of VLC link with UE is completed, the value of i depends on the downlink channel quality measurement over the VLC link. Wherein the channel quality measurement includes, but not limited to, SINR, RSRP, RSRQ and other information measured over the VLC link. Preferably, the value of i depends on the downlink SINR measured over the VLC link.

Specifically, for a service whose traffic is first carried by WLAN link and later taken over by VLC link, when the considered indoor user completes the building of VLC connectivity, denote the packet index of the packet currently transmitted by WLAN link as k. At the time point when the building of VLC connectivity is completed, the transmission of packet k via WLAN may be just completed or may be in progress. Then, “the time point for making content transmission be transferred to VLC link” is chosen as “the starting time point of transmission for the packet with the packet index being k+i (i>=1)”. That is to say, in order to ensure the transmitted contents to be smoothly linked up between WLAN link and VLC link, we suggest that the content transmission is transferred to VLC link since the beginning of an incoming packet, with avoiding the possibility of starting from the middle of packet k. The value of the abovementioned i (i>=1) depends on when the DL SINR measured over the newly established VLC link becomes good enough (e.g., larger than a pre-defined threshold). At the earliest, the contents will be transferred from WLAN link to VLC link since the starting time point of the immediately next packet of the currently transmitted packet (i.e., i=1).

FIG. 2 shows an exemplary DL data transmission mechanism. In this example, for a service whose traffic is first carried by WiFi link and later taken over by VLC link, when the considered indoor user completes the building of VLC link, denote the packet index of the packet currently transmitted by WiFi link as k, at the time point, the considered user completes the building of VLC connectivity while the DL WiFi transmission of packet k has not been completed, the considered user have both WiFi and VLC link with 6G CPE for user plane, then, the DL data transmission are transferred to VLC link since the beginning of an incoming packet (which is packet k+1 in this example).

In some embodiments, the last packet transmitted through the VLC link is retransmitted through WLAN link when the VLC link is lost.

In some embodiments, after DL data transmission is transferred from WLAN link to VLC link, the indoor user may change back to WLAN link soon, due to mobility (e.g., this user walks out of the VLC coverage) or possible variation of interference. In this case, although the data rate of VLC link is quite high, maybe, the DL data transmission of the corresponding service has not been finished, because of the period of time for using VLC link is short. If the DL data transmission of the corresponding service has not been finished, denote the packet index of the last packet transmitted by VLC link as m. At the time point when the VLC connectivity is lost, the transmission of packet m via VLC may be just completed or may be in progress.

This disclosure also suggested that, after the wireless connection is changed back to WLAN link, the packet m is re-transmitted via WLAN link before transmitting the remaining packets using WLAN link. By doing so, the transmitted contents can be smoothly linked up between VLC link and WLAN link, with ensuring the integrality of packet transmission while avoiding the possibility of continuing the transmission from the middle of packet m.

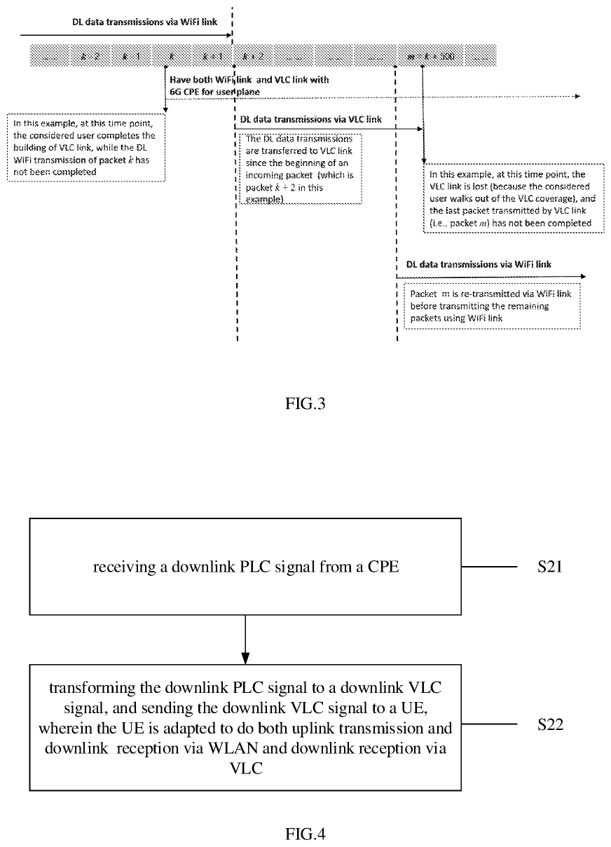

FIG. 3 shows an exemplary DL data transmission mechanism. In this example, for a service whose traffic is first carried by WiFi link and later taken over by VLC link, when the considered indoor user completes the building of VLC link, denote the packet index of the packet currently transmitted by WiFi link as k, at the time point, the considered user completes the building of VLC connectivity while the DL WiFi transmission of packet k has not been completed, the considered user have both WiFi and VLC link with 6G CPE for user plane; then, the DL data transmission are transferred to VLC link since the beginning of an incoming packet (which is packet k+2 in this example); at the time point when the VLC link is lost, the transmission of packet m (m=k+500) via VLC is in progress, the packet m is re-transmitted via WiFi link before transmitting the remaining packets using WiFi link.

FIG. 4 shows an exemplary flow chart for communications in a VLC-enabled illuminating device according to an embodiment of the present disclosure. Wherein the VLC-enabled illuminating device is connected to CPE through power line, and has a module to do transformation between PLC signals and VLC signals. The VLC-enabled illuminating device may be adapted to do DL transmission via VLC, or it may be adapted to do both DL transmission and UL reception via VLC. The method according to the embodiment includes steps S21 and S22.

In the step S21, the VLC-enabled illuminating device receives a downlink PLC signal from a CPE. Wherein, the downlink PLC signal is transformed, by the CPE, from a downlink cellular mobile signal sent from an outdoor base station if the downlink cellular mobile signal is handled by VLC link.

In the step S22, the VLC-enabled illuminating device transforms the downlink PLC signal to a downlink VLC signal, and sending the downlink VLC signal to a UE, wherein the UE is adapted to do both uplink transmission and downlink reception via WLAN and downlink reception via VLC. For example, the UE includes a WiFi transceiver and a VLC receiver, upon receiving a 6G signal sent from an outdoor 6G base station, the CPE transforms the 6G signal to a downlink PLC signal and sends the downlink PLC signal to a VLC-enabled illuminating device through power line if the 6G signal is handled by VLC link, the VLC-enabled illuminating device receives the downlink PLC signal, then transforms the downlink PLC signal to a downlink VLC signal and sends the downlink VLC signal to the UE. Alternatively, the VLC-enabled illuminating device may have or may not have the ability for uplink transmission via VLC.

In some embodiments, the method in the VLC-enabled illuminating device further comprises: receiving an uplink VLC signal sent from the UE, wherein the UE is also adapted to do uplink transmission via VLC; transforming the uplink VLC signal to an uplink PLC signal, and sending the uplink PLC signal to the CPE. It should be noted that, if the UE is not adapted to do uplink transmission via VLC, the VLC-enabled illuminating device will not receive any uplink signals sent from UE, that is, the UE can only use WLAN link to transmit uplink signals.

FIG. 5 shows an exemplary flow chart for communications in a UE according to an embodiment of the present disclosure. Wherein the UE is adapted to do both uplink transmission and downlink reception via WLAN and downlink reception via VLC. Alternatively, the UE is also adapted to do uplink transmission via VLC. The method according to the embodiment includes step S31.

In the step S31, the UE receives a downlink VLC signal from a VLC-enabled illuminating device and/or a downlink WLAN signal from a CPE, wherein the downlink VLC signal is transformed from a downlink PLC signal sent from the CPE. For example, upon receiving a 6G signal sent from an outdoor 6G base station, the CPE transforms the 6G signal to a downlink PLC signal and sends the downlink PLC signal to a VLC-enabled illuminating device through power line if the 6G signal is handled by VLC link, the VLC-enabled illuminating device receives the downlink PLC signal, then transforms the downlink PLC signal to a downlink VLC signal and sends the downlink VLC signal to the UE, then the UE receives the downlink VLC signal. For another example, upon receiving a 6G signal sent from an outdoor 6G base station, the CPE transforms the 6G signal to a downlink WiFi signal and sends the downlink WiFi signal to a UE if the 6G signal is handled by WiFi link, then the UE receives the downlink WiFi signal. For another example, upon receiving a 6G signal sent from an outdoor 6G base station, the CPE transforms part of the 6G signal to a downlink WiFi signal and transforms the other part of the 6G signal to a downlink PLC signal, then the CPE sends the downlink WiFi signal to a UE and sends the downlink PLC signal to a VLC-enabled illuminating device through power line, the UE receives the downlink WiFi signal sent from the CPE and a downlink VLC signal sent from the VLC-enabled illuminating device, wherein the downlink VLC signal is transformed from the downlink PLC signal by the VLC-enabled illuminating device.

In some embodiments, the UE is connected to the CPE via WLAN link and VLC link after moving into the overlapped coverage of WLAN network and VLC network, the step S31 comprises: receiving a downlink VLC signal from the VLC-enabled illuminating device and/or a downlink WLAN signal from the CPE according to the working mode of the UE, wherein the working mode of the UE is determined according to its service type and/or its wireless channel condition; and the method further comprises: sending an uplink WLAN signal to the CPE if the UE is not adapted to do uplink transmission via VLC, or sending an uplink WLAN signal to the CPE and/or an uplink VLC signal to a VLC-enabled illuminating device according to the working mode of the UE if the UE is also adapted to do uplink transmission via VLC.

In some embodiments, at either downlink or uplink direction, the working mode is any of the following modes: WLAN single-link mode, VLC single-link mode, traffic splitting mode; wherein, all the currently activated services of the UE are handled by WLAN link in the WLAN single-link mode, all the currently activated services of the UE are handled by VLC link in the VLC single-link mode, some services of the UE which have high demand on throughput are handled by VLC link and other services of the UE are handled by WLAN link in the traffic splitting mode. For any user that has both WLAN link and VLC link with the CPE described in this disclosure, its working mode would be adaptively varied according to the type(s) of its service(s) and the condition of its experienced wireless propagation environment.

In a word, for an indoor user that has both WiFi link and VLC like with the CPE described in this disclosure, at any one given time slot, its working mode would be one of the following three modes:
i) WLAN single-link mode where all the currently activated services of this user are handled by WLAN link.
ii) VLC single-link mode where all the currently activated services of this user are handled by VLC link.
iii) traffic splitting mode where some service(s) of this user which do not have high demand on throughput are handled by WLAN link, while other service(s) of this user which have high demand on throughput are handled by VLC link.

In some embodiments, the VLC link between a UE and an outdoor VLC-enabled illuminating device is established if the UE is outdoors, some services of the UE which have high demand on throughput are handled by VLC link; wherein the downlink VLC signal is transformed from a downlink PLC signal sent from the CPE and the uplink VLC signal is transformed to an uplink PLC signal sent to the CPE if the UE is also adapted to do uplink transmission via VLC. Preferably, the outdoor VLC-enabled illuminating device is located near the CPE, Alternatively, the outdoor UE may keep both the VLC link with the outdoor VLC-enabled illuminating device and a cellular mobile communication link with an outdoor base station, other services of the outdoor UE can be handled by the cellular mobile communication link.

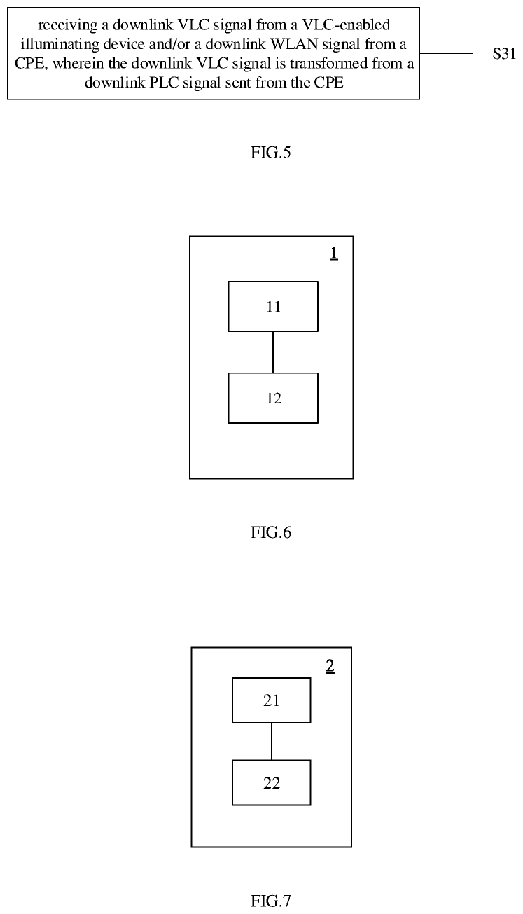

FIG. 6 shows an exemplary structural diagram of a first apparatus for communications in a CPE according to an embodiment of the present disclosure. The first apparatus 1 includes means 11 and means 12.

The term CPE described in this disclosure can support not only the transformation between cellular mobile signals and WLAN signals, but also the transformation between cellular mobile signals and PLC signals. The cellular mobile signals include signals in existing or future cellular mobile systems, such as 2G/3G/4G/5G/6G signals. Using 6G as an example, the CPE consists of a 6G UE modem chipset, a networking processor, a WLAN modem chipset, and a PLC modem chipset, in DL, the CPE has the ability to transform 6G signals sent from an outdoor 6G base station to either PLC signals or WLAN signals, in UL, the CPE has the ability to transform PLC signals or WLAN signals to 6G signals. What needs to be explained is, about whether VLC will be viewed as one WLAN technique in the future, it is an unknown issue now, but, in this disclosure, the term WLAN explicitly and definitely excludes VLC. In some preferred embodiments, the term WLAN described in this disclosure means WiFi.

The means 11 is used for receiving a downlink cellular mobile signal from an outdoor base station. The outdoor base station is the serving base station of the CPE. For example, the means 11 receives a downlink 6G signal sent from an outdoor 6G base station.

The means 12 is used for transforming the downlink cellular mobile signal to a downlink WLAN signal and sending the downlink WLAN signal to a UE when the downlink cellular mobile signal is handled by WLAN link, and/or transforming the downlink cellular mobile signal to a downlink PLC signal and sending the downlink PLC signal to a VLC-enabled illuminating device when the downlink cellular mobile signal is handled by VLC link. The UE described in this disclosure is adapted to do both uplink transmission and downlink reception via WLAN and downlink reception via VLC, for example, the UE includes a WiFi transceiver and a VLC receiver. In this disclosure, the realistic PLC-assisted VLC subsystem is considered, specifically the CPE connected to multiple VLC-enabled illuminating device through power lines, each VLC-enabled illuminating device (i.e., each VLC AP) has a signal transformation module which is used for transforming between PLC signals and VLC signals. As an example, in DL, upon receiving, by the means 11, a 6G signal sent from an outdoor 6G base station which is the serving 6G base station of the CPE, the means 12 first transforms the 6G signal to L3 user plane data, then transforms the L3 user-plane data to a downlink WLAN signal (e.g., a downlink WiFi signal) if the 6G signal is handled by WLAN link (e.g., WiFi link), and then sends the downlink WLAN signal to a UE. As another example, in DL, upon receiving, by the means 11, a 6G signal sent from an outdoor 6G base station which is the serving 6G base station of the CPE, the means 12 first transforms the 6G signal to L3 user plane data, then transforms the L3 user plane data to a downlink PLC signal if the 6G signal is handled by VLC link, and then sends the downlink PLC signal to a VLC-enabled illuminating device, the VLC-enabled illuminating device will transform the PLC signal to a VLC signal and send the VLC signal to a UE. In some embodiments, in DL, upon receiving a 6G signal sent from an outdoor 6G base station which is the serving 6G base station of the CPE, the CPE transforms part of the 6G signal to a downlink WiFi signal and transforms the other part of the 6G signal to a downlink PLC signal, then the CPE sends the downlink WiFi signal to a UE and sends the downlink PLC signal to a VLC-enabled illuminating device through power line.

In some embodiments, the first apparatus 1 further comprises: means 13 (not shown) for receiving an uplink WLAN signal sent from the UE and/or an uplink PLC signal sent from the VLC-enabled illuminating device, and transforming the uplink WLAN signal and/or the uplink PLC signal to an uplink cellular mobile signal, wherein the uplink PLC signal is generated at the VLC-enabled illuminating device by transforming the uplink VLC signal sent from the UE that also adapted to do uplink transmission via VLC; means 14 (not shown) for sending the uplink cellular mobile signal to the outdoor base station.

In some embodiments, the means 13 receives an uplink WLAN signal sent from the UE, and transforms an uplink WLAN signal to an uplink cellular mobile signal, then the means 14 sends the uplink cellular mobile signal to the outdoor base station. If the indoor UE does not have the ability to do UL transmission via VLC (i.e., the UE is not adapted to do UL transmission via VLC), the means 13 can only receive uplink WLAN signals sent from the UE.

In some embodiments, the means 13 receives an uplink PLC signal sent from the VLC-enabled illuminating device, and transforms the uplink PLC signal to an uplink cellular mobile signal, then the means 14 sends the uplink cellular mobile signal to the outdoor base station, wherein the uplink PLC signal is generated at the VLC-enabled illuminating device by transforming the uplink VLC signal sent from the UE, wherein the UE is also adapted to do uplink transmission via VLC. In these embodiments, the indoor UE can do UL transmission via not only WLAN but also VLC, and the VLC-enabled illuminating devices are adapted to do not only DL transmission but also UL reception via VLC.

In some embodiments, the means 13 receives an uplink WLAN signal sent from the UE and an uplink PLC signal sent from the VLC-enabled illuminating device, then transforms the uplink PLC signal and the uplink PLC signal to an uplink cellular mobile signal, the means 14 sends the uplink cellular mobile signal to the outdoor base station.

In other words, in UL, two optional subcases as following are considered:
i) if indoor users (i.e., UEs) do not have the ability to do UL transmission via VLC, this CPE receives WLAN signals sent from indoor users and transforms these WLAN signals to be cellular mobile signals;
ii) if indoor users can do UL transmission via not only WLAN but also VLC and if the VLC-enabled illuminating devices have the ability for not only DL transmission but also UL reception via VLC, the CPE receives WLAN signals (sent from some indoor users) and PLC signals (transformed by VLC signals sent from another indoor users), and then transforms these WLAN signals and PLC signals to be cellular mobile signals.

In the prior art, the VLC subsystem accesses the backbone network in wired way via ethernet and hierarchical gateways, so that VLC subsystem is completely independent of cellular mobile systems. With the usage of the CPE described in this disclosure, the VLC subsystem can really be integrated into cellular mobile communication systems (such as 6G or other future cellular mobile communication systems), because the VLC subsystem accesses the backbone network in wireless way via RAN of cellular mobile systems. In another words, the signals of indoor users (which are able to do VLC for at least DL) would go through RAN and core network of cellular mobile communication systems before accessing application (e.g., Internet application), resulting in shorter end-to-end transmission latency than prior VLC solutions and making the VLC subsystem become a part of 6G cellular mobile systems.

Considering that the co-existence of WLAN and VLC for indoor coverage is a reasonable deployment tendency in the future, this disclosure uses the co-deployment of WLAN and VLC as the basic network deployment for indoor coverage. In some embodiments, with the management of the CPE described in this disclosure, the indoor coverage could be viewed as being implemented by the co-existence of VLC AP(s) and WLAN AP(s). That is to say, the CPE acts as both a WLAN AP and an OLC type VLC AP.

In terms of WLAN access, one CPE generally acts as one WLAN AP for the communications between CPE and indoor user(s).

In terms of VLC access, one CPE acts as one OLC-type VLC AP for the communications between CPE and indoor user(s). That is, all the VLC-enabled illuminating devices, which share one common PLC modem in the CPE, formulate one OLC-type VLC AP (i.e., all of these VLC-enabled illuminating devices have one unified cell ID); in this way, the frequent handover between VLC-enabled illuminating devices could be avoided. In contrast, for the existing way, each VLC-enabled illuminating devices is a VLC AP and has a unique cell ID, so that a handover procedure (including several control signals) will be initiated, once the considered indoor user walks from the coverage of one VLC-enabled illuminating device into the coverage of another neighboring VLC-enabled illuminating device; thus, in general, frequent handover (which means a significant amount of control overhead) between VLC-enabled illuminating devices will be caused, because the distance between any two indoor VLC-enabled illuminating devices are generally close.

In some embodiments, one or more pure WLAN routers are bridged with the CPE to act as secondary WLAN APs based on using WLAN bridging technology, and/or, one or more pure PLC routers are bridged with the CPE based on using PLC bridging technology where all the VLC-enabled illuminating devices that share one bridged PLC router formulate a secondary OLC-type VLC AP. For example, if needed (e.g., in a house with two floors), another one or more pure WiFi router(s) can, based on using WiFi bridging technology, be bridged with the CPE to act as secondary WiFi AP(s). For another example, if needed, another one or more pure PLC router(s) can, based on using PLC bridging technology, be bridged with the CPE, and all the VLC-enabled illuminating devices that share one bridged PLC router formulate a secondary OLC-type VLC AP.

Under the co-existence of VLC and WLAN for indoor coverage, VLC coverage is generally a subset of WLAN coverage. For any WLAN user which moves into the overlapped coverage of VLC and WLAN, it is proposed in this disclosure to let this user keep both WLAN link and VLC link with the CPE. Then, with the dual connectivity, no handover between WLAN AP and VLC AP is needed.

Using the DL user-plane transmission as the example, for any WLAN user that moves into the overlapped coverage of VLC and WLAN, once the user builds VLC link, for some service(s) of the user which have high demand on throughput (e.g., file downloading, on-line movie watching, etc.), the corresponding data transmission will be taken over by VLC link.

The peak throughput of VLC could reach several Gbps (based on the existing experiments), which is much larger than the peak throughput of WLAN. Thus, as the examples, once the DL data transmission of the corresponding service(s) are taken over by VLC link, the file downloading will be completed soon and the on-line movie watching will become much smoother. For making DL data transmission is smoothly linked up between WLAN link and VLC link, this disclosure proposes the following transmission mechanism.

In some embodiments, the UE is connected to the CPE via both WLAN link and VLC link after moving into the overlapped coverage of WLAN network and VLC network, for a service whose traffic is first carried by WLAN link and later taken over by VLC link, the starting time point of transmission for the packet with the packet index k+i (i>=1) is taken as the starting time point of data transmission through the VLC link, k is the packet index of the packet currently transmitted by WLAN link when the establishment of VLC link with UE is completed, the value of i depends on the downlink channel quality measurement over the VLC link. Wherein the channel quality measurement includes, but not limited to, SINR, RSRP, RSRQ and other information measured over the VLC link. Preferably, the value of i depends on the downlink SINR measured over the VLC link.

Specifically, for a service whose traffic is first carried by WLAN link and later taken over by VLC link, when the considered indoor user completes the building of VLC connectivity, denote the packet index of the packet currently transmitted by WLAN link as k. At the time point when the building of VLC connectivity is completed, the transmission of packet k via WLAN may be just completed or may be in progress. Then, “the time point for making content transmission be transferred to VLC link” is chosen as “the starting time point of transmission for the packet with the packet index being k+i (i>=1)”. That is to say, in order to ensure the transmitted contents to be smoothly linked up between WLAN link and VLC link, we suggest that the content transmission is transferred to VLC link since the beginning of an incoming packet, with avoiding the possibility of starting from the middle of packet k. The value of the abovementioned i (i>=1) depends on when the DL SINR measured over the newly established VLC link becomes good enough (e.g., larger than a pre-defined threshold). At the earliest, the contents will be transferred from WLAN link to VLC link since the starting time point of the immediately next packet of the currently transmitted packet (i.e., i=1).

FIG. 2 shows an exemplary DL data transmission mechanism. In this example, for a service whose traffic is first carried by WiFi link and later taken over by VLC link, when the considered indoor user completes the building of VLC link, denote the packet index of the packet currently transmitted by WiFi link as k, at the time point, the considered user completes the building of VLC connectivity while the DL WiFi transmission of packet k has not been completed, the considered user have both WiFi and VLC link with 6G CPE for user plane, then, the DL data transmission are transferred to VLC link since the beginning of an incoming packet (which is packet k+1 in this example).

In some embodiments, the last packet transmitted through the VLC link is retransmitted through WLAN link when the VLC link is lost.

In some embodiments, after DL data transmission is transferred from WLAN link to VLC link, the indoor user may change back to WLAN link soon, due to mobility (e.g., this user walks out of the VLC coverage) or possible variation of interference. In this case, although the data rate of VLC link is quite high, maybe, the DL data transmission of the corresponding service has not been finished, because of the period of time for using VLC link is short. If the DL data transmission of the corresponding service has not been finished, denote the packet index of the last packet transmitted by VLC link as m. At the time point when the VLC connectivity is lost, the transmission of packet m via VLC may be just completed or may be in progress.

This disclosure also suggested that, after the wireless connection is changed back to WLAN link, the packet m is re-transmitted via WLAN link before transmitting the remaining packets using WLAN link. By doing so, the transmitted contents can be smoothly linked up between VLC link and WLAN link, with ensuring the integrality of packet transmission while avoiding the possibility of continuing the transmission from the middle of packet m.

FIG. 3 shows an exemplary DL data transmission mechanism. In this example, for a service whose traffic is first carried by WiFi link and later taken over by VLC link, when the considered indoor user completes the building of VLC link, denote the packet index of the packet currently transmitted by WiFi link as k, at the time point, the considered user completes the building of VLC connectivity while the DL WiFi transmission of packet k has not been completed, the considered user have both WiFi and VLC link with 6G CPE for user plane; then, the DL data transmission are transferred to VLC link since the beginning of an incoming packet (which is packet k+2 in this example); at the time point when the VLC link is lost, the transmission of packet m (m=k+500) via VLC is in progress, the packet m is re-transmitted via WiFi link before transmitting the remaining packets using WiFi link.

FIG. 7 shows an exemplary structural diagram of a second apparatus for communications in a VLC-enabled illuminating device according to an embodiment of the present disclosure. Wherein the VLC-enabled illuminating device is connected to CPE through power line, and has a module to do transformation between PLC signals and VLC signals. The VLC-enabled illuminating device may only have be adapted to do DL transmission via VLC, or it may be adapted to do both DL transmission and UL reception via VLC. The second apparatus 2 according to the embodiment includes means 21 and means 22.

The means 21 is used for receiving a downlink PLC signal from a CPE. Wherein, the downlink PLC signal is transformed, by the CPE, from a downlink cellular mobile signal sent from an outdoor base station if the downlink cellular mobile signal is handled by VLC link.

The means 22 is used for transforming the downlink PLC signal to a downlink VLC signal, and sending the downlink VLC signal to a UE, wherein the UE is adapted to do both uplink transmission and downlink reception via WLAN and the ability for downlink reception via VLC. For example, the UE includes a WiFi transceiver and a VLC receiver, upon receiving a 6G signal sent from an outdoor 6G base station, the CPE transforms the 6G signal to a downlink PLC signal and sends the downlink PLC signal to a VLC-enabled illuminating device through power line if the 6G signal is handled by VLC link, the means 21 receives the downlink PLC signal, then the means 22 transforms the downlink PLC signal to a downlink VLC signal and sends the downlink VLC signal to the UE. Alternatively, the VLC-enabled illuminating device may have or may not have the ability for uplink transmission via VLC.

In some embodiments, the second apparatus 2 further comprises: means 23 (not shown) for receiving an uplink VLC signal sent from the UE, wherein the UE is also adapted to do uplink transmission via VLC; means 24 (not shown) for transforming the uplink VLC signal to an uplink PLC signal, and sending the uplink PLC signal to the CPE. It should be noted that, if the UE is not adapted to do uplink transmission via VLC, the VLC-enabled illuminating device will not receive any uplink signals sent from UE, that is, the UE can only use WLAN link to transmit uplink signals.

FIG. 8 shows an exemplary structural diagram of a third apparatus for communications in a UE according to an embodiment of the present disclosure. Wherein the UE is adapted to do both uplink transmission and downlink reception via WLAN and downlink reception via VLC. Alternatively, the UE is also adapted to do uplink transmission via VLC. The third apparatus 3 according to the embodiment includes means 31.

The means 31 is used for receiving a downlink VLC signal from a VLC-enabled illuminating device and/or a downlink WLAN signal from a CPE, wherein the downlink VLC signal is transformed from a downlink PLC signal sent from the CPE. For example, upon receiving a 6G signal sent from an outdoor 6G base station, the CPE transforms the 6G signal to a downlink PLC signal and sends the downlink PLC signal to a VLC-enabled illuminating device through power line if the 6G signal is handled by VLC link, the VLC-enabled illuminating device receives the downlink PLC signal, then transforms the downlink PLC signal to a downlink VLC signal and sends the downlink VLC signal to the UE, then the means 31 in the UE receives the downlink VLC signal. For another example, upon receiving a 6G signal sent from an outdoor 6G base station, the CPE transforms the 6G signal to a downlink WiFi signal and sends the downlink WiFi signal to a UE if the 6G signal is handled by WiFi link, then the means 31 in the UE receives the downlink WiFi signal. For another example, upon receiving a 6G signal sent from an outdoor 6G base station, the CPE transforms part of the 6G signal to a downlink WiFi signal and transforms the other part of the 6G signal to a downlink PLC signal, then the CPE sends the downlink WiFi signal to a UE and sends the downlink PLC signal to a VLC-enabled illuminating device through power line, the means 31 in the UE receives the downlink WiFi signal sent from the CPE and a downlink VLC signal sent from the VLC-enabled illuminating device, wherein the downlink VLC signal is transformed from the downlink PLC signal by the VLC-enabled illuminating device.

In some embodiments, the UE is connected to the CPE via both WLAN link and VLC link after moving into the overlapped coverage of WLAN network and VLC network, the means 31 is used for receiving a downlink VLC signal from the VLC-enabled illuminating device and/or a downlink WLAN signal from the CPE according to the working mode of the UE, wherein the working mode of the UE is determined according to its service type and/or its wireless channel condition; and the third apparatus 3 further comprises: means 32 (not shown) for sending an uplink WLAN signal to the CPE if the UE is not adapted to do uplink transmission via VLC, or sending an uplink WLAN signal to the CPE and/or an uplink VLC signal to a VLC-enabled illuminating device according to the working mode of the UE if the UE is also adapted to do uplink transmission via VLC.

In some embodiments, at either downlink or uplink direction, the working mode is any of the following modes: WLAN single-link mode, VLC single-link mode, traffic splitting mode; wherein, all the currently activated services of the UE are handled by WLAN link in the WLAN single-link mode, all the currently activated services of the UE are handled by VLC link in the VLC single-link mode, some services of the UE which have high demand on throughput are handled by VLC link and other services of the UE are handled by WLAN link in the traffic splitting mode. For any user that has both WLAN link and VLC link with the CPE described in this disclosure, its working mode would be adaptively varied according to the type(s) of its service(s) and the condition of its experienced wireless propagation environment.

In a word, for an indoor user that has both WiFi link and VLC like with the CPE described in this disclosure, at any one given time slot, its working mode would be one of the following three modes:
i) WLAN single-link mode where all the currently activated services of this user are handled by WLAN link.
ii) VLC single-link mode where all the currently activated services of this user are handled by VLC link.
iii) traffic splitting mode where some service(s) of this user which do not have high demand on throughput are handled by WLAN link, while other service(s) of this user which have high demand on throughput are handled by VLC link.

In some embodiments, the VLC link between a UE and an outdoor VLC-enabled illuminating device is established if the UE is outdoors, some services of the UE which have high demand on throughput are handled by VLC link; wherein the downlink VLC signal is transformed from a downlink PLC signal sent from the CPE and the uplink VLC signal is transformed to an uplink PLC signal sent to the CPE if the UE is also adapted to do uplink transmission via VLC. Preferably, the outdoor VLC-enabled illuminating device is located near the CPE, Alternatively, the outdoor UE may keep both the VLC link with the outdoor VLC-enabled illuminating device and a cellular mobile communication link with an outdoor base station, other services of the outdoor UE can be handled by the cellular mobile communication link.

In some embodiments, the UE described in this disclosure includes at least the following: at least one processor; at least one memory; a battery module; a WLAN transceiver for downlink reception and uplink transmission of a WLAN signal; a VLC receiver for downlink reception of a VLC signal; one or more ADC/DAC module for conversion between a digital signal and an analog signal. Wherein, the battery module is used to provide power for the UE, the ADC/DAC module is used for conversion between digital signals and analog signals. In some embodiments, the VLC receiver may be a camera or the screen of the UE. In some embodiments, the processor includes a baseband processor and an application processor. In some embodiments, the UE further comprises a VLC transmitter for uplink transmission of a VLC signal. In some embodiments, the VLC receiver and the VLC transmitter can be integrated into one transceiver. In some embodiments, the UE further comprises at least one of the following: SIM (Subscriber Identity Module) card; a BT (Bluetooth) transceiver; a GNSS (Global Navigation Satellite System) transceiver; a cellular mobile signal transceiver for downlink reception and uplink transmission of a cellular mobile signal; camera; speaker; MIC (Microphone); screen. Wherein any explanation of the UE with reference to the above embodiments is incorporated here by reference.

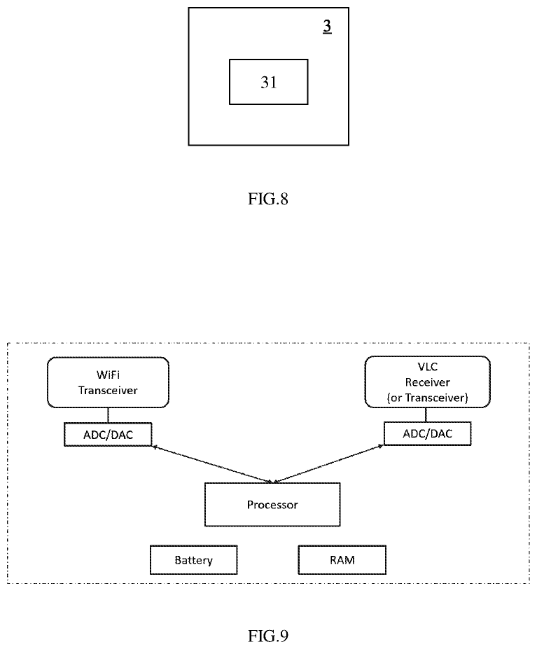

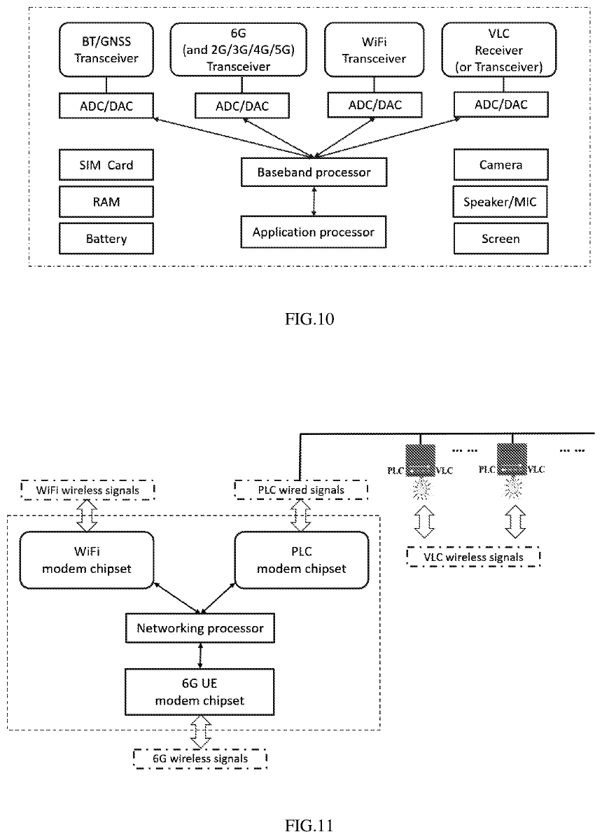

FIG. 9 shows an exemplary structural diagram of UE according to an embodiment of the present disclosure. The UE according to the embodiment includes a Battery module, a RAM (random access memory), a Processor, a WiFi Transceiver, a VLC Receiver (or Transceiver), one ADC/DAC module connected to the WiFi Transceiver and another to the VLC Receiver (or Transceiver). Wherein the Battery module is used to provide power for the UE, the ADC/DAC module is used for conversion between digital signals and analog signals, the WiFi Transceiver is used for transmission and reception of WiFi signal, the VLC Receiver is used for reception of VLC signals, the VLC Transceiver is used for transmission and reception of VLC signals.

FIG. 10 shows an exemplary structural diagram of UE according to an embodiment of the present disclosure. The UE according to the embodiment includes a Battery module, a RAM, SIM Card, a Baseband processor, an Application processor, a BT/GNSS Transceiver, a 6G (and 2G/3G/4G/5G) Transceiver, a WiFi Transceiver, a VLC Receiver (or Transceiver), ADC/DAC modules connected to each transceiver separately, Camera, Speaker/MIC, Screen. Wherein, 2G/3G/4G/5G Transceiver may exist for backward compatibility of cellular mobile communication systems. In some embodiments, there are not the SIM Card and the 6G (and 2G/3G/4G/5G) Transceiver in the UE, in this case, the UE is not capable of directly accessing cellular mobile communication systems.

It should be explained that, VLC frequency spectrum range is “400 THz 800 THz”, which has a very large separation when compared to “cmWave” (for wide-area coverage of 6G networks) and “mmWave & <10 THz” (for smallcell or hotpot coverage of 6G networks), thus, in a UE described in this disclosure, there is no issue of electromagnetic coupling between VLC transceiver and another RF transceivers (such as WiFi transceiver, 6G (and 2G/3G/4G/5G) transceiver).

This disclosure also provides a CPE, comprising: at least one memory; a battery module; a UE modem chipset for L1 and L2 processing of a cellular mobile signal, L3 control-plane processing of the cellular mobile signal, none or part of L3 user-plane processing of the cellular mobile signal, wherein, the UE modem chipset is used for transformation between a cellular mobile signal and IP data packets; a networking processor for all or part of L3 user-plane processing of the cellular mobile signal, L3 processing of a WLAN signal, L3 processing of a PLC signal, O&M configuration of the accessed UEs, wherein, the networking processor is used for sending IP data packets sent from the UE modem chipset into the WLAN modem chipset and/or the PLC modem chipset, or sending IP data packets sent from the WLAN modem chipset and/or the PLC modem chipset into the UE modem chipset; a WLAN modem chipset for L1 and L2 processing of the WLAN signal, wherein, the WLAN modem chipset is used for transformation between IP data packets and WLAN signal; a PLC modem chipset for L1 and L2 processing of the PLC signal, wherein, the PLC modem chipset is used for transformation between IP data packets and PLC signal. In some embodiments, the networking processor is used for all L3 user-plane processing of the cellular mobile signal; in some embodiments, the UE modem chipset is configured for a part of L3 user-plane processing of the cellular mobile signal, and the networking processor is configured for the other part of L3 user-plane processing of the cellular mobile signal. Wherein any explanation of the CPE with reference to the above embodiments is incorporated here by reference. For example, in DL, upon receiving a downlink cellular mobile signal sent from an outdoor base station (which is the serving base station of the considered CPE), the UE modem chipset decodes the downlink cellular mobile signal and exports L3 user-plane data (i.e., IP data packets), then, the IP data packets are sent into the networking processor, the networking processor shall further send the IP data packets into the WLAN modem chipset and/or the PLC modem chipset, the WLAN modem chipset can transform the received IP data packets to be a downlink WLAN signal, the PLC modem chipset can transform the received IP data packets to be a downlink PLC signal (which will be further sent to some VLC-enabled illuminating device(s)).

FIG. 11 shows an exemplary system for communications according to an embodiment of the present disclosure. For simplicity, only CPE and VLC-enabled illuminating devices are shown in the system of FIG. 11, and the outdoor base station and UE(s) are not shown. The CPE in FIG. 11 includes a 6G UE modem chipset, a networking processor, a WiFi modem chipset, and a PLC modem chipset. Wherein, the functionalities of the 6G UE modem chipset could include the module for L1 and L2 processing of 6G signals, the module for L3 control-plane processing of 6G signals, and the module for “up to tethering” parts in L3 user-plane processing of 6G signals; alternatively, the last one L3 module mentioned above could also be included by the networking processor, depending on the specific implementation. Wherein, the functionalities of the networking processor could include the module for O&M that can perform remote management of the access indoor terminals, the module for “above tethering” parts in L3 user-plane processing of 6G signals (e.g., network address translation (NAT) part), L3 processing of WiFi signals, and L3 processing of PLC signals. Wherein, the WiFi modem chipset is used to perform L1 and L2 processing of WiFi signals, the PLC modem chipset is used to perform L1 and L2 processing of PLC signals.

This disclosure also provides a CPE for communications, comprising:
at least one processor; and
at least one memory including computer program code;
the at least one memory and the computer program code configured to, with the at least one processor, cause the CPE at least to perform:
receiving a downlink cellular mobile signal from an outdoor base station;
transforming the downlink cellular mobile signal to a downlink WLAN signal and sending the downlink WLAN signal to a UE when the downlink cellular mobile signal is handled by WLAN link, and/or transforming the downlink cellular mobile signal to a downlink PLC signal and sending the downlink PLC signal to a VLC-enabled illuminating device when the downlink cellular mobile signal is handled by VLC link;
wherein the UE is adapted to do both uplink transmission and downlink reception via WLAN and downlink reception via VLC.

The operations of the CPE are similar with the steps that have been described above and will not repeated herein.

This disclosure also provides a VLC-enabled illuminating device for communications, comprising:
at least one processor; and
at least one memory including computer program code;
the at least one memory and the computer program code configured to, with the at least one processor, cause the VLC-enabled illuminating device at least to perform:
receiving a downlink PLC signal from a CPE;
transforming the downlink PLC signal to a downlink VLC signal, and sending the downlink VLC signal to a UE, wherein the UE is adapted to do both uplink transmission and downlink reception via WLAN and downlink reception via VLC.

The operations of the VLC-enabled illuminating device are similar with the steps that have been described above and will not repeated herein.

This disclosure also provides a UE for communications, wherein the UE is adapted to do both uplink transmission and downlink reception via WLAN and downlink reception via VLC, comprising:
at least one processor; and
at least one memory including computer program code;
the at least one memory and the computer program code configured to, with the at least one processor, cause the UE illuminating device at least to perform:
receiving a downlink VLC signal from a VLC-enabled illuminating device and/or a downlink WLAN signal from a CPE, wherein the downlink VLC signal is transformed from a downlink PLC signal sent from the CPE.
The operations of the UE are similar with the steps that have been described above and will not repeated herein.

This disclosure also provides a non-transitory computer readable medium comprising program instructions for causing a device to perform at least the following:
receiving a downlink cellular mobile signal from an outdoor base station;
transforming the downlink cellular mobile signal to a downlink WLAN signal and sending the downlink WLAN signal to a UE when the downlink cellular mobile signal is handled by WLAN link, and/or transforming the downlink cellular mobile signal to a downlink PLC signal and sending the downlink PLC signal to a VLC-enabled illuminating device when the downlink cellular mobile signal is handled by VLC link;
wherein the UE is adapted to do both uplink transmission and downlink reception via WLAN and downlink reception via VLC.

This disclosure also provides a non-transitory computer readable medium comprising program instructions for causing a device to perform at least the following:
receiving a downlink PLC signal from a CPE;
transforming the downlink PLC signal to a downlink VLC signal, and sending the downlink VLC signal to a UE, wherein the UE is adapted to do both uplink transmission and downlink reception via WLAN and downlink reception via VLC.

This disclosure also provides a non-transitory computer readable medium comprising program instructions for causing a device which is adapted to do both uplink transmission and downlink reception via WLAN and downlink reception via VLC to perform at least the following:
receiving a downlink VLC signal from a VLC-enabled illuminating device and/or a downlink WLAN signal from a CPE, wherein the downlink VLC signal is transformed from a downlink PLC signal sent from the CPE.

In general, various embodiments may be implemented in hardware or special purpose circuitry, software, logic or any combination thereof. For example, some aspects may be implemented in hardware, while other aspects may be implemented in firmware or software which may be executed by a controller, microprocessor or other computing device, although the present disclosure is not limited thereto. While various aspects of the present disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example, embodiments of the present disclosures may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used in this disclosure, the term “memory” may refer to the collection of storage units or devices, the term “at least one memory” described in this disclosure may be regarded as a memory module, the memory module may include one or more memories, and those skilled in the art should understand that a plurality of memories can work together as required when the memory module includes the plurality of memories. A memory may include computer system readable media in the form of volatile memory, such as a RAM and/or a cache memory, and may include at least one program product having a set of (for example, at least one) program modules configured to perform the functions of the embodiments of the present disclosure. A program/utility with a set of program modules may be stored in, for example, the memory, such program module includes, but is not limited to, an operating system, one or more application programs, other program modules and program data, and each or some combination of these examples may include an implementation of network environment, the program module generally performs the functions and/or methods in the described embodiments of the present disclosure.

As used in this disclosure, the term “processor” may refer to a unit for information processing and program running, the term “at least one processor” described in this disclosure may be regarded as a processor module, the processor module may include one or more processors, and those skilled in the art should understand that a plurality of processors can work together as required when the processor module includes the plurality of processors. The processor module may perform various functional applications and data processing through running programs stored in the memory module. For example, the memory module stores the computer programs for performing various functions and processes of the present disclosure, and when the corresponding computer programs are executed by the processor module, the method for communications according to the present disclosure is implemented.

It needs to be noted that, the present disclosure may be implemented in software and/or in a combination of software and hardware. For example, the various apparatuses of the present disclosure may be implemented using an Application Specific Integrated Circuit (ASIC) or any other similar hardware device. In one embodiment, the software programs of the present disclosure may be executed by a processor in order to carry out the steps or functions mentioned above. Likewise, the software programs of the present disclosure, including the related data structures, may be stored in a computer readable medium. The computer readable medium may be a computer readable signal medium or a computer readable storage medium. A computer readable storage medium may be, for example, but not limited to, an electric, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a Random Access Memory (RAM), a Read-only Memory (ROM), an Erasable Programmable Read-only Memory (EPROM or Flash memory), an optical fiber, a portable Compact Disc Read-only Memory (CD-ROM), an optical storage device, a magnetic storage device, or any suitable combination of the foregoing. In the context of this document, a computer readable storage medium may be any tangible medium that contains or stores programs for use by or in connection with an instruction execution system, apparatus or device.

A computer readable signal medium may include a data signal, with computer readable program code carried therein, propagated in baseband or as part of a carrier wave. Such a propagated data signal may take any of a variety of forms, including, but not limited to, an electromagnetic signal, an optical signal, or any suitable combination thereof. A computer readable signal medium may also be any computer readable medium that is not a computer readable storage medium and can communicate, propagate or transport programs for use by or in connection with an instruction execution system, apparatus or device.

Program code contained on a computer readable medium may be transmitted using any appropriate medium, including but not limited to wireless, wireline, optical fiber cable, RF, etc., or any suitable combination of the foregoing.

Computer program code for carrying out operations of the present disclosure may be written in one or more programming languages or a combination thereof, including object-oriented programming languages such as Java, Smalltalk, C++ or the like, and conventional procedural programming languages such as the “C” language or similar programming languages.

In addition, some of the steps or functions of the present disclosure may be implemented in hardware, for example, as a circuit that cooperates with a processor in order to perform each step or function.

As used in this disclosure, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in the present disclosure, including in any claims. As a further example, as used in the present disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The word “example” is used herein to mean “serving as an example, instance, or illustration.” Any embodiment described herein as “example” is not necessarily to be construed as preferred or advantageous over other embodiments. All of the embodiments described in this Detailed Description are example embodiments provided to enable persons skilled in the art to make or use the present disclosure and not to limit the scope of the present disclosure which is defined by the claims.

The foregoing description has provided by way of example and non-limiting examples a full and informative description of the best method and apparatus presently contemplated by the inventors for carrying out the present disclosure. However, various modifications and adaptations may become apparent to those skilled in the relevant arts in view of the foregoing description, when read in conjunction with the accompanying drawings and the appended claims. However, all such and similar modifications of the teachings of this present disclosure will still fall within the scope of this present disclosure.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of some example embodiments of this present disclosure could be used to advantage without the corresponding use of other features. As such, the foregoing description should be considered as merely illustrative of the principles of the present disclosure, and not in limitation thereof.

1. A method for communications in a customer premise equipment (CPE), said method comprising:
receiving a downlink cellular mobile signal from an outdoor base station; and
transforming the downlink cellular mobile signal to a downlink wireless local area network (WLAN) signal and sending the downlink WLAN signal to a user equipment (UE) when the downlink cellular mobile signal is handled by WLAN link, and/or transforming the downlink cellular mobile signal to a power line communications (PLC) signal and sending the downlink PLC signal to a visible light communications (VLC)-enabled illuminating device when the downlink cellular mobile signal is handled by VLC link;
wherein the UE is adapted to do both uplink transmission and downlink reception via WLAN and downlink reception via VLC.

2. The method of claim 1, further comprising:
receiving an uplink WLAN signal sent from the UE and/or an uplink PLC signal sent from the VLC-enabled illuminating device, and transforming the uplink WLAN signal and/or the uplink PLC signal to an uplink cellular mobile signal, wherein the uplink PLC signal is generated at the VLC-enabled illuminating device by transforming the uplink VLC signal sent from the UE that also adapted to do uplink transmission via VLC; and
sending the uplink cellular mobile signal to the outdoor base station.

3. (canceled)

4. (canceled)

5. A method for communications in a visible light communications (VLC)-enabled illuminating device, comprising:
receiving a downlink power line communications (PLC) signal from a customer premise equipment (CPE); and
transforming the downlink PLC signal to a downlink VLC signal, and sending the downlink VLC signal to a user equipment (UE), wherein the UE is adapted to do both uplink transmission and downlink reception via WLAN and downlink reception via VLC.

6. (canceled)

7. A method for communications in a user equipment (UE), wherein the UE is adapted to do both uplink transmission and downlink reception via wireless local area network (WLAN) and downlink reception via visible light communications (VLC), comprising:
receiving a downlink VLC signal from a VLC-enabled illuminating device and/or a downlink WLAN signal from a customer premise equipment (CPE), wherein the downlink VLC signal is transformed from a downlink power line communications (PLC) signal sent from the CPE.

8. (canceled)

9. (canceled)

10. (canceled)

11. The CPE of claim 20, wherein the at least one memory and computer program code, when executed by the at least one processor, further cause the CPE to perform:
receiving an uplink WLAN signal sent from the UE and/or an uplink PLC signal sent from the VLC-enabled illuminating device; and
transforming the uplink WLAN signal and/or the uplink PLC signal to an uplink cellular mobile signal,
wherein the uplink PLC signal is generated at the VLC-enabled illuminating device by transforming the uplink VLC signal sent from the UE that also adapted to do uplink transmission via VLC.

12. The CPE of claim 20, wherein the UE is connected to the CPE via both WLAN link and VLC link after moving into the overlapped coverage of WLAN network and VLC network, for a service whose traffic is first carried by WLAN link and later taken over by VLC link, the starting time point of transmission for the packet with the packet index k+i (i>=1) is taken as the starting time point of data transmission through the VLC link, k is the packet index of the packet currently transmitted by WLAN link when the establishment of VLC link with UE is completed, the value of i depends on the downlink channel quality measurement measured over the VLC link.

13. The CPE of claim 20, wherein the CPE acts as both a WLAN access point (AP) and a one logical cell (OLC)-type VLC AP, wherein, the role of the OLC-type VLC AP is formed by making all the VLC-enabled illuminating devices that share the PLC modem in the CPE have one unique cell identifier (ID).

14. (canceled)

15. The VLC-enabled illuminating device of claim 21, wherein the at least one memory and computer program code, when executed by the at least one processor, further cause the device to perform:
receiving an uplink VLC signal sent from the UE, wherein the UE is also adapted to do uplink transmission via VLC; and
transforming the uplink VLC signal to an uplink PLC signal, and sending the uplink PLC signal to the CPE.

16. (canceled)

17. The UE of claim 22, wherein the UE is connected to the CPE via both WLAN link and VLC link after moving into the overlapped coverage of WLAN network and VLC network, and wherein the at least one memory and computer program code, when executed by the at least one processor, cause the UE to further perform:
receiving a downlink VLC signal from the VLC-enabled illuminating device and/or a downlink WLAN signal from the CPE according to the working mode of the UE, wherein the working mode of the UE is determined according to its service type and/or its wireless channel condition;
determining the working mode of the UE according to its service type and/or its wireless channel condition; and
sending an uplink WLAN signal to the CPE if the UE is not adapted to do uplink transmission via VLC, or sending an uplink WLAN signal to the CPE and/or an uplink VLC signal to the VLC-enabled illuminating device according to the working mode of the UE if the UE is also adapted to do uplink transmission via VLC.

18. The UE of claim 22, wherein the VLC link between the UE and an outdoor VLC-enabled illuminating device is established if the UE is outdoors, some services of the UE which have high demand on throughput are handled by VLC link; wherein the downlink VLC signal is transformed from a downlink PLC signal sent from the CPE and the uplink VLC signal is transformed to a uplink PLC signal sent to the CPE if the UE is also adapted to do uplink transmission via VLC.

19. A customer premise equipment (CPE) for communications, comprising:
at least one memory;
a battery module;
a user equipment (UE) modem chipset for L1 and L2 processing of a cellular mobile signal, L3 control-plane processing of the cellular mobile signal, none or part of L3 user-plane processing of the cellular mobile signal, wherein, the UE modem chipset is used for transformation between a cellular mobile signal and IP data packets;
a networking processor for all or part of L3 user plane processing of the cellular mobile signal, L3 processing of a wireless local area network (WLAN) signal, L3 processing of a power line communications (PLC) signal, operation and maintenance (O&M) configuration of the accessed UEs, wherein the networking processor is used for sending internet protocol (IP) data packets sent from the UE modem chipset into the WLAN modem chipset and/or the PLC modem chipset, or sending IP data packets sent from the WLAN modem chipset and/or the PLC modem chipset into the UE modem chipset;
a WLAN modem chipset for L1 and L2 processing of a WLAN signal, wherein, the WLAN modem chipset is used for transformation between IP data packets and WLAN signal; and
a PLC modem chipset for L1 and L2 processing of a PLC signal, wherein, the PLC modem chipset is used for transformation between IP data packets and PLC signal.

20. A customer premise equipment (CPE) for communications, comprising:
at least one processor; and
at least one memory including computer program code;
the at least one memory and the computer program code configured to, with the at least one processor, cause the CPE at least to perform:
receiving a downlink cellular mobile signal from an outdoor base station;
transforming the downlink cellular mobile signal to a downlink wireless local area network (WLAN) signal and sending the downlink WLAN signal to a user equipment (UE) when the downlink cellular mobile signal is handled by WLAN link, and/or transforming the downlink cellular mobile signal to a downlink power line communications (PLC) signal and sending the downlink PLC signal to a visible light communications (VLC)-enabled illuminating device when the downlink cellular mobile signal is handled by VLC link;
wherein the UE is adapted to do both uplink transmission and downlink reception via WLAN and downlink reception via VLC.

21. A visible light communications (VLC)-enabled illuminating device for communications, comprising:
at least one processor; and
at least one memory including computer program code;
the at least one memory and the computer program code configured to, with the at least one processor, cause the VLC-enabled illuminating device at least to perform:
receiving a downlink power line communications (PLC) signal from a customer premise equipment (CPE);
transforming the downlink PLC signal to a downlink VLC signal, and sending the downlink VLC signal to a user equipment (UE), wherein the UE is adapted to do both uplink transmission and downlink reception via wireless local area network (WLAN) and downlink reception via VLC.

22. A user equipment (UE) for communications, wherein the UE is adapted to do both uplink transmission and downlink reception via wireless local area network (WLAN) and downlink reception via visible light communications (VLC), comprising:
at least one processor; and
at least one memory including computer program code;
the at least one memory and the computer program code configured to, with the at least one processor, cause the UE at least to perform:
receiving a downlink VLC signal from a VLC-enabled illuminating device and/or a downlink WLAN signal from a customer premise equipment (CPE), wherein the downlink VLC signal is transformed from a downlink power line communications (PLC) signal sent from the CPE.

23. A non-transitory computer readable medium comprising program instructions for causing a device to perform the method claim 1.

24. A non-transitory computer readable medium comprising program instructions for causing a device to perform the method of claim 5.

25. A non-transitory computer readable medium comprising program instructions for causing a device which is adapted to do both uplink transmission and downlink reception via wireless local area network (WLAN) and downlink reception via visible light communications (VLC) to perform the method of claim 7.
